(19) United States
(12) Patent Application Publication
(10) Pub. No.: US 2019/0004947 A1
(43) Pub. Date: Jan. 3, 2019

(54) SELECTIVE TEMPORARY DATA STORAGE

(71) Applicant: Intel Corporation, Santa Clara, CA (US)

(72) Inventor: SANJEEV N. TRIKA, Portland, OR (US)

(73) Assignee: Intel Corporation, Santa Clara, CA (US)

(21) Appl. No.: 15/639,382

(22) Filed: Jun. 30, 2017

(51) Int. Cl. G06F 12/0804; G06F 3/06; G06F 12/0891; G06F 9/44; G06F 11/20

(52) U.S. Cl. CPC G06F 12/0804; G06F 2201/82; G06F 3/0647; G06F 3/0659; G06F 3/0685; G06F 12/0891; G06F 9/4406; G06F 9/442; G06F 9/4418; G06F 11/2094; G06F 2212/1008; G06F 2212/1032; G06F 2212/205; G06F 2201/805; G06F 3/0619

(57) ABSTRACT

One embodiment provides host device. The host device includes a host processor circuitry; a host memory circuitry, and a host storage logic to determine whether a data to be stored is temporary or persistent and to provide a write (Write) command associated with the data to a storage device, if the data is persistent data, or to provide a volatile write (vWrite) command associated with the data to the storage device, if the data is temporary data.

Another embodiment provides a storage device. The storage device includes a device processor circuitry; a volatile memory circuitry; a nonvolatile memory circuitry; and a device storage logic to store a persistent data to the nonvolatile memory circuitry in response to a write (Write) command from a host device and a temporary data to the volatile memory circuitry in response to a volatile write (vWrite) command from the host device.

### FIELD

The present disclosure relates to temporary data storage, in particular to, selective temporary data storage.

### BACKGROUND

In some computing systems, an operating system (OS) executing on a host device may be configured to save data to a storage device. Write operations associated with some (e.g., memory-intensive) workloads may correspond to a majority of write requests on a system. Some of the saved data may not be needed across a shutdown and/or a restart of the host system. For example, pagefile data and selected temporary files saved on the storage device prior to the shutdown and/or restart may not be utilized by the host device after the corresponding shutdown and/or restart.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a selective temporary data storage system consistent with several embodiments of the present disclosure;

FIG. 2 is a flowchart of host device operations according to various embodiments of the present disclosure; and

FIG. 3 is a flowchart of storage device operations according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

The storage device may be unable to differentiate data that should be available across the shutdown and/or restart from data that may be discarded if a shutdown and/or restart occurs. Thus, the storage device may be configured to save all data to nonvolatile media (“NV-media”) in the storage device. In some situations, the storage device may be configured to flush the data to NV-media using stored (e.g., capacitance) energy in case of a power failure. Thus, storage device resources may be consumed storing data that may not be used by the host system after the shutdown and/or restart.

Generally, this disclosure relates to selective temporary data storage. A host device is configured to store temporary data and persistent data to a storage device. The storage device may include both volatile memory circuitry and nonvolatile memory (NVM) circuitry, e.g., nonvolatile media. Volatile memory is configured to maintain stored information while powered. NVM is configured to retain stored information after power is removed and the stored information may thus be available if power is restored.

The host device is configured to store the temporary data using a volatile write (“vWrite”) command and the persistent data using an ordinary write (“Write”) command. The Write command may comply and/or be compatible with a storage device communication interface/protocol, e.g., NVMe (Nonvolatile Memory Express), as described herein. The respective command syntax for Write and vWrite may be similar or the same, with a difference being a respective opcode. Thus, Write and vWrite may each include address information and an amount of data to be written, along with the respective opcode. The vWrite command is configured to communicate to the storage device that the associated data to be stored is temporary. The Write command is configured to communicate to the storage device that the associated data to be stored is persistent. As used herein, temporary data is data stored prior to a shutdown and/or a restart that is not used following the shutdown and/or restart. As used herein, persistent data is data to be stored prior to a change in system power state that may be used following the change in system power state. System power states may include, but are not limited to, powered up, shut down, restart, standby, hibernate, sleep, power failure, etc. Temporary data may include, for example, pagefile data and selected temporary files that may not be utilized after the corresponding shutdown and/or restart.

The storage device is configured to store the persistent data to a nonvolatile memory circuitry and to store the temporary data to a volatile memory circuitry. The storage device may store the persistent data to the volatile memory circuitry, e.g., the volatile memory circuitry may be used as a storage device cache. The persistent data may be later stored to nonvolatile memory. In other words, the volatile memory circuitry, in this situation, may act as a write-back cache. The storage device is configured to store the persistent data to the nonvolatile memory circuitry and to invalidate the stored temporary data in response to a discard volatile shutdown (“dvShutdown”) command. In one example, the temporary data may be invalidated prior to shutting down. In another example, the temporary may be flagged as temporary and may then be invalidated upon a subsequent power up of the storage device. Invalidating the temporary data in response to the dvShutdown command is configured to result in the temporary data being at least one of discarded, trimmed and/or unmapped. In other words, invalidating temporary data is configured to indicate to the storage device that the temporary data is no longer in use and, thus, may be erased, e.g., during garbage collection. The host device is configured to provide the dvShutdown command to the storage device in advance of a system shutdown and/or restart. The storage device may invalidate temporary data in response to an indication of an imminent power failure of the storage device, as described herein.

In situations where the temporary data should be available after a return from a power management event that includes powering down the volatile memory circuitry, the host device is configured to provide a Shutdown, e.g., a Standby immediate, command to the storage device in advance of the power management event. Power management events that include powering down the volatile memory circuitry may include, but are not limited to, a change in system power state to a system standby and/or a hibernate power state. In response to a Shutdown command, the storage device is configured to store the temporary data (and the persistent data) to the nonvolatile memory circuitry. Thus, the temporary data (and the persistent data) may be available following the system standby and/or hibernate power states.

Thus, unnecessary storage of temporary data across a system shutdown and/or restart may be avoided and availability of temporary data across a system standby and/or hibernate may be retained. The storage device may be configured to store the temporary data to volatile memory circuitry (e.g., dynamic random access memory (DRAM) and/or static random access memory (SRAM)) included in the storage device. Whether data to be stored is temporary or persistent is indicated by the respective write command (vWrite or Write). Whether temporary data should be invalidated or stored to nonvolatile media in advance of a change in system power state is indicated by the respective change of power state command (Shutdown, e.g., Standby-immediate, or dvShutdown). The Write, Shutdown and Standby-immediate commands may comply and/or be compatible with one or more storage device (e.g., NVMe-based) protocols including, but not limited to, PCIe (Peripheral Component Interconnect Express), NVMe (Non-Volatile Memory Express), SCSI (Small Computer System Interface), AHCI (Advance Host Controller Interface), SATA (Serial ATA (Advanced Technology Attachment)), PATA (Parallel ATA), etc. In some embodiments, the vWrite and/or dvShutdown commands may comply and/or be compatible with one or more of the nonvolatile memory protocols. In some embodiments, the vWrite and/or dvShutdown commands may be vendor-specific extensions to a storage device protocol. In some embodiments, the vWrite and/or dvShutdown commands may be optional features of a storage device protocol, e.g., NVMe.

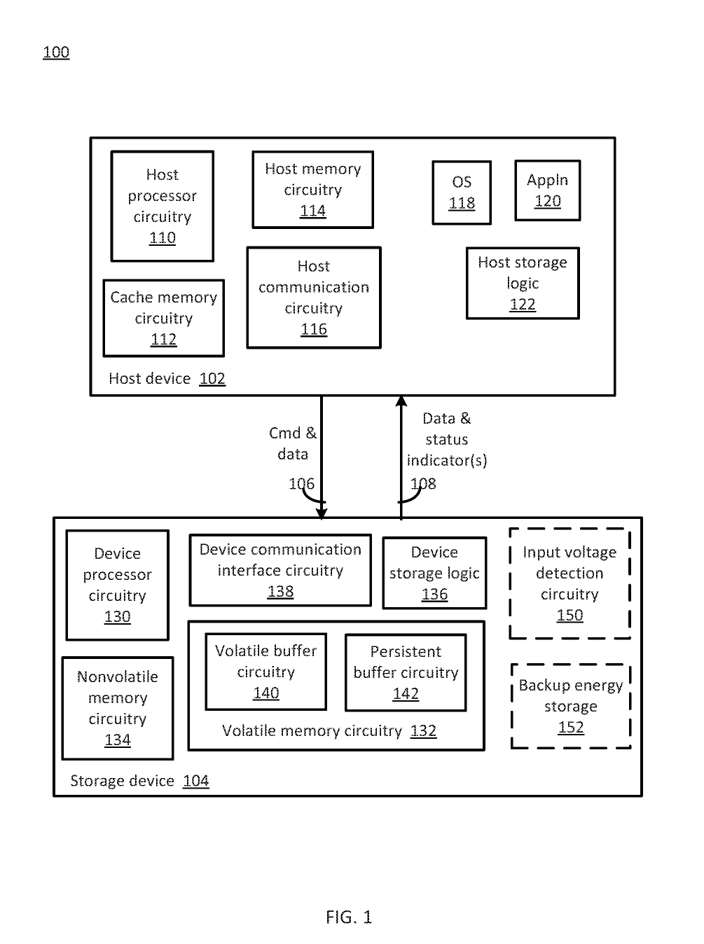

FIG. 1 illustrates a functional block diagram of a selective temporary data storage system 100 consistent with several embodiments of the present disclosure. System 100 includes a host device 102 and a storage device 104. The storage device 104 may be coupled to and/or included in host device 102. System 100 and host device 102 may have a plurality of system power states. System power states may include, but are not limited to, powered up, shut down, restart, standby, hibernate, sleep, power failure, etc. The host device 102 is configured to provide commands and/or data 106 to the storage device 104. The storage device 104 is configured to provide data and/or one or more status indicator(s) 108 to host device 102. The commands may include, but are not limited to, Read, Write, vWrite, Shutdown, dvShutdown, etc.

Host device 102 may include, but is not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; an Internet of Things (IoT) networked device including, but not limited to, a sensor system (e.g., environmental, position, motion, etc.) and/or a sensor network (wired and/or wireless); a computing system (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer; etc. Host device 102 includes a host processor circuitry 110, a cache memory circuitry 112, a host memory circuitry 114 and a host communication circuitry 116. For example, host processor circuitry 110 may correspond to a single core or a multi-core general purpose processor, such as those provided by Intel® Corp., etc. The cache memory circuitry 112 may be coupled to and/or included in host processor circuitry 110. Host device 102 may further include an operating system (OS) 118 and one or more applications, e.g., application 120. Host device 102 may further include a host storage logic 122. Host storage logic 122 may be coupled to and/or included in OS 118 and/or application 120.

Storage device 104 may include, but is not limited to, a solid-state drive (SSD), a hard disk drive (HDD), a network attached storage (NAS) system, a storage area network (SAN) and/or a redundant array of independent disks (RAID) system, etc. Storage device 104 includes a device processor circuitry 130, a volatile memory circuitry 132 and a nonvolatile memory circuitry 134. Storage device 104 may further include a device storage logic 136. Storage device 104 may further include a device communication interface circuitry 138. Volatile memory circuitry 132 may include volatile random-access memory, e.g., dynamic random access memory (DRAM) and/or static random access memory (SRAM), etc. Device processor circuitry 130 may include, but is not limited to, a microcontroller, an application-specific integrated circuit (ASIC), a programmable logic device (PLD), a complex PLD, etc.

Volatile memory circuitry may be a storage medium that requires power to maintain the state of data stored by the medium. Non-limiting examples of volatile memory circuitry may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

Volatile memory circuitry 132 may correspond to volatile storage. In other words, data stored (i.e., written) to volatile memory circuitry 132 may remain in volatile memory circuitry 132 as long as storage device 104 is powered. If power is removed from storage device 104, data stored to volatile memory circuitry 132 may be lost. Data stored to nonvolatile memory circuitry 134 may be retained after power is removed from storage device 104 and may then be retrieved, i.e., read from, nonvolatile memory circuitry 134 when storage device 104 is again powered.

Nonvolatile memory circuitry 134 includes a storage medium that does not require power to maintain the state of data stored in the storage medium. In one embodiment, the nonvolatile memory circuitry may correspond to a block addressable memory device, such as those based on NAND or NOR technologies. The nonvolatile memory circuitry may also include future generation nonvolatile devices, such as a three dimensional crosspoint memory device, or other byte addressable write-in-place nonvolatile memory devices. Nonvolatile memory circuitry 134 may include, but is not limited to, a NAND flash memory (e.g., a Triple Level Cell (TLC) NAND or any other type of NAND (e.g., Single Level Cell (SLC), Multi Level Cell (MLC), Quad Level Cell (QLC), etc.)), NOR memory, solid state memory (e.g., planar or three Dimensional (3D) NAND flash memory or NOR flash memory), multi-threshold level NAND flash memory, NOR flash memory, storage devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), byte addressable random accessible 3D crosspoint memory, ferroelectric transistor random access memory (Fe-TRAM), anti-ferroelectric memory, magnetoresistive random access memory (MRAM) that incorporates memristor technology, single or multi-level phase change memory (PCM, PRAM), resistive memory including the metal oxide base, the oxygen vacancy base and the conductive bridge Random Access Memory (CB-RAM), ferroelectric memory (F-RAM, FeRAM), spin-transfer torque memory (STT), STT-MRAM, thermal assisted switching memory (TAS), millipede memory, floating junction gate memory (FJG RAM), a spintronic magnetic junction memory based device, magnetic tunnel junction (MTJ) memory, electrochemical cells (ECM) memory, binary oxide filament cell memory, interfacial switching memory, battery-backed RAM, ovonic memory, nanowire memory, electrically erasable programmable read-only memory (EEPROM), a DW (Domain Wall) and SOT (Spin Orbit Transfer) based device, a thyristor based memory device, or a combination of any of the above, or other memory. The memory device may refer to the die itself and/or to a packaged memory product. In some embodiments, the byte addressable random accessible 3D crosspoint memory may include a transistor-less stackable cross point architecture in which memory cells sit at the intersection of words lines and bit lines and are individually addressable and in which bit storage is based on a change in bulk resistance.

In operation, host device 102 is configured to store data to storage device 104. Data may be written to or read from storage device 104 by OS 118 and/or application 120 via host storage logic 122. In one example, the data may be associated with execution of application 120. In another example, the data may be associated with operation of OS 118.

OS 118 and/or application 120 may be configured to provide host storage logic 122 an indication that there is data to be stored to storage device 104. Data to be stored may include persistent and/or temporary data. Host storage logic 122 may then be configured to determine whether the data to store is temporary data or persistent data. If the data to store is persistent data, then host storage logic 122 may be configured to provide a Write command to storage device 104, e.g., to device storage logic 136. The Write command may include, as parameters (i.e., as arguments), a logical block address (LBA), a length of a block of data to be stored and one or more data pointers. Device storage logic 136 may then be configured to retrieve and/or receive the data to store, and to write the persistent data to volatile memory circuitry 132 and/or nonvolatile memory circuitry 134.

If the data to store is temporary data, then host storage logic 122 may be configured to provide a volatile Write (vWrite) command to storage device 104, e.g., to device storage logic 136. For example, the OS 118 may expose the vWrite command to the application 120. The application 120 and/or the OS 120 may then be configured to utilize the vWrite command to write temporary data to storage device 104 and, e.g., volatile memory circuitry 132. Similar to the Write command, the vWrite command may include, as parameters (i.e., as arguments), a logical block address (LBA), a length of a block of data to be stored and one or more data pointers. Device storage logic 136 may then be configured to retrieve and/or receive the data to store, and to write the temporary data to volatile memory circuitry 132.

In some embodiments, temporary data may be stored to nonvolatile memory circuitry 134. The temporary data may then be invalidated in response to a shutdown/restart (e.g., in response to a dvShutdown command) and/or an indication of an imminent power loss to the storage device 104. Invalidating the temporary data is configured to indicate that the temporary data may be discarded, trimmed and/or unmapped in response to a shutdown/restart. In one example, temporary data stored to nonvolatile memory circuitry 134 may be flagged as temporary. The flagged temporary data may then be invalidated by device storage logic 136 upon subsequent system 100 and storage device 104 power up. In this manner, relatively less energy may be consumed in response to the dvShutdown and/or power loss imminent indicator. In another example, the temporary data may be invalidated in response to, e.g., a dvShutdown command and/or in indication of imminent power loss, prior to shutting down and/or actual power loss.

Thus, whether the data to store is persistent or temporary may be indicated to the storage device 104 by the host device 102 according to whether the command to store the data is a Write command or a vWrite command. In one embodiment, the vWrite command may be a specific command vWrite command. In another embodiment, the vWrite command may correspond to a Write command with a parameter configured to indicate that the associated data to be written is temporary.

Device storage logic 136 may be configured to associate persistent data and temporary data with a respective data type indicator (i.e., persistent or temporary). In an embodiment, volatile memory circuitry 132 may include a volatile buffer circuitry 140 and a persistent buffer circuitry 142. Device storage logic 136 may be configured to store temporary data in volatile buffer circuitry 140. Device storage logic 136 may be further configured to store persistent data in persistent buffer circuitry 142. In one example, the volatile buffer circuitry 140 and the persistent buffer circuitry 142 may correspond to fixed respective regions of volatile memory circuitry 132. In another example, the volatile buffer circuitry 140 and the persistent buffer circuitry 142 may be dynamically allocated by, for example, device storage logic 136.

In another embodiment, each data frame may include one bit configured to indicate whether the associated data in the data frame is temporary or persistent. In an embodiment, a reserved bit in a command structure of, for example, NVMe protocol, may be utilized. For example, one bit of bits 10 through 13 of an NVMe submission queue command dword0 may be used with an opcode corresponding to a write (Write or vWrite) command. For example, a data frame bit equal to 1 may correspond to temporary data and a data frame bit equal to 0 may correspond to persistent data. In another embodiment, device storage logic 136 may be configured to partition volatile memory circuitry 132 into volatile buffer circuitry 140 and persistent buffer circuitry 142. Volatile buffer circuitry 140 is configured to store temporary data and persistent buffer circuitry 142 is configured to store persistent data, as described herein. For example, volatile buffer circuitry 140 may correspond to DRAM and the persistent buffer circuitry 142 may correspond to SRAM that may be flushed to NVM in response to a change in power state. Any volatile memory circuitry may be used for the persistent buffer circuitry. Similarly, a storage device transfer buffer may be maintained in SRAM and flushed to NVM in response to a change in power state.

Memory access operations associated with temporary data stored in volatile memory circuitry 132 may correspond to memory access operations to cache memory. For example, memory access operations may include a write caching technique. Write caching techniques may include, but are not limited to, write-buffering, prioritized write-back inserts, LRU (least recently used), FIFO (first in, first out), etc.

Device storage logic 136 may be configured to check for a collision in volatile memory circuitry 132 in response to a Write and/or a vWrite command. In other words, similar to writes to a cache memory, a collision may occur if more than one processor thread attempts to write to a same cache and/or cache location. Thus, device storage logic 136 may be configured to check for a collision in volatile memory circuitry 132. Device storage logic 136 may be configured to invalidate the associated data (temporary and/or persistent), if a collision is detected.

It may be appreciated that, while the host device 102 is powered up, operations of OS 118 and/or application 120 may include a number of memory access operations associated with storage device 104. Over time, temporary data that has been stored in volatile memory circuitry 132 in response to a vWrite command, may differ from corresponding data stored, for example, in host memory circuitry 114. In other words, a “dirty bit” associated with a temporary data value may be set. Device storage logic 136 may be configured to not flush corresponding “dirty” temporary data to nonvolatile memory circuitry 134, in response to a dvShutdown command and/or power-failure. Similarly, device storage logic 136 may be configured to not flush dirty temporary data in response to a Flush command.

OS 118 and/or host storage logic 122 may be configured to detect an indication of an imminent change of system power state from a current system power state (e.g., powered up) to a new system power state. OS 118 and/or host storage logic 122 may be further configured to determine whether the new system power state corresponds to standby and/or hibernate (“standby/hibernate”) or shutdown and/or restart (“shutdown/restart”). OS 118 and/or host storage logic 122 may be further configured to determine whether the new system power state corresponds to a power management event that turns off volatile memory circuitry 132 but includes retaining the associated data for access following a subsequent power up. If the new system power state corresponds to standby/hibernate, then host storage logic 122 may be configured to provide a Shutdown, e.g., Standby immediate, command to storage device 104 and/or device storage logic 136. The Shutdown command is configured to cause the storage device 104 (e.g., device storage logic 136) to write temporary data (and persistent data, if any) stored in volatile memory circuitry 132 to nonvolatile memory circuitry 134, so that the temporary data (and persistent data, if any) may be available upon system 100 exit from the standby/hibernate system power state.

If the new power state corresponds to shutdown/restart, then OS 118, via host storage logic 122, may be configured to provide a discard volatile Shutdown (dvShutdown) command to storage device 104 and/or device storage logic 136. The dvShutdown command is configured to cause the storage device 104 (e.g., device storage logic 136) to write only persistent data, if any, stored in volatile memory circuitry 132 to nonvolatile memory circuitry 134, so that the persistent data may be available when the system power state returns to powered up after the shutdown/restart system power state. The storage device 104 (e.g., device storage logic 136) is configured to not write temporary data stored in volatile memory circuitry 132 to nonvolatile memory circuitry 134. In other words, temporary data stored in volatile memory circuitry 132 may be invalidated by a shutdown/restart system power state. The temporary data may include “dirty” temporary data, as described herein. Thus, the temporary data may not be available upon power-up following the shutdown/restart system power state.

Thus, a Shutdown command or a dvShutdown command, selected based, at least in part, on an imminent change of system power state, may be provided to the storage device 104 by the host device 102.

Thus, temporary data is not guaranteed to be available across boots or power failures, i.e., following a system shutdown/restart and/or power failure. For example, the temporary data may be stored to volatile memory circuitry 132 and not to nonvolatile memory circuitry 134 by a previously completed vWrite operation. In another example, persistent data and not temporary data may be stored to nonvolatile memory circuitry 134 by setting a Force Unit Access (FUA) condition. In another example, persistent data and not temporary data may be stored to nonvolatile memory circuitry 134 by a completed subsequent Flush command. Thus, write operations of temporary data from volatile memory circuitry 132 to nonvolatile memory circuitry 134 may be avoided.

Memory access operations by OS 118 and/or application 120 may further include read operations configured to read temporary and/or persistent data. Thus, in response to a read request (i.e., Read command), device storage logic 136 may be configured to first determine whether the requested data is stored in the volatile memory circuitry 132. If the requested data is not stored in the volatile memory circuitry 132, the device storage logic 136 may be configured to access nonvolatile memory circuitry 134 to read the requested data. For example, the requested temporary data may have been stored in nonvolatile memory circuitry 134 in response to a Shutdown command prior to the system entering a standby/hibernate system power state. The requested temporary data may then be available in the nonvolatile memory circuitry 134 after the system 100 exits the standby/hibernate system power state.

Read operations to the storage device 104 may utilize cache read techniques. For example, cache read techniques may include accessing the volatile memory circuitry 132 first, i.e., prior to accessing nonvolatile memory circuitry 134. In another example, cache read techniques may include utilizing read spanning for requested data that includes a portion stored in volatile memory circuitry 132 and a portion stored in nonvolatile memory circuitry 134.

In some embodiments, storage device 104 may include an input voltage detection circuitry 150 and a backup energy storage circuitry 152. For example, backup energy storage circuitry may correspond to a capacitor. In another example, backup energy storage circuitry 152 may correspond to a battery or other energy storage device. The input voltage detection circuitry 150 is configured to monitor an input supply voltage to the storage device 104. Monitoring the input supply voltage is configured to detect an imminent supply power loss (i.e., power failure) to the storage device 104. If the input supply voltage decreases to less than an input supply voltage threshold, the input voltage detection circuitry 150 is configured to notify the device storage logic 136. For example, notifying the device storage logic 136 may include providing a dvShutdown command to the device storage logic 136. In another example, notifying the device storage logic 136 may include providing a power loss imminent indicator to the device storage logic 136. Device storage logic 136 may then be configured to write persistent data stored in volatile memory circuitry 132 to nonvolatile memory circuitry 134. Device storage logic 136 may be further configured to invalidate temporary data (or flag temporary data currently stored to nonvolatile memory circuitry 134 as temporary, as described herein) in response to the imminent power loss indicator. Storage device 104 may be configured to utilize energy stored in backup energy storage circuitry 152 to support operation of storage device 104.

Thus, unnecessary storage of temporary data across a system shutdown and/or restart and/or storage device power failure may be avoided and availability of temporary data across a system standby and/or hibernate may be retained. Thus, storage device 102 resources may be used relatively more efficiently.

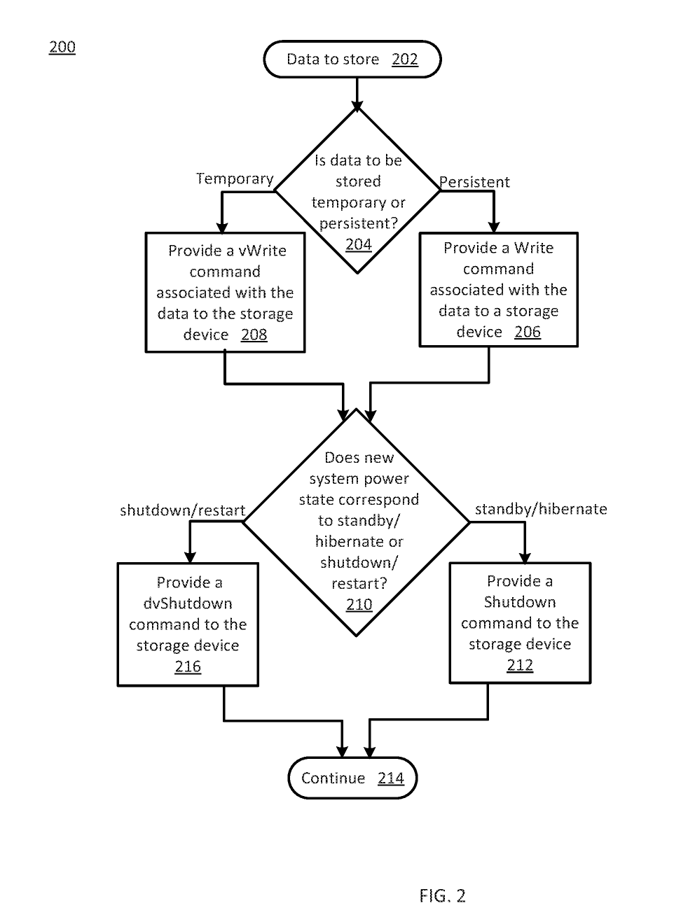

FIG. 2 is a flowchart 200 of host device operations according to various embodiments of the present disclosure. In particular, the flowchart 200 illustrates storing temporary and/or persistent data to a storage device and instructing the storage device whether to store or invalidate the temporary data if a change in system power state is imminent. The operations may be performed, for example, by host device 102, e.g., host storage logic 122, of FIG. 1.

Operations of this embodiment may begin with an indication of data to store at operation 202. Operation 204 includes determining whether a data to be stored is temporary or persistent. Operation 206 includes providing a write (Write) command associated with the data to a storage device, if the data is persistent data. Program flow may then proceed to operation 210. Operation 208 includes providing a volatile write (vWrite) command associated with the data to the storage device, if the data is temporary data. Program flow may then proceed to operation 210.

Operation 210 includes determining whether a new system power state corresponds to at least one of standby and/or hibernate (standby/hibernate) or at least one of shutdown and/or restart (shutdown/restart). Operation 212 includes providing a shutdown (Shutdown) command to the storage device if the new system power state is standby/hibernate. Program flow may then continue at operation 214. Operation 216 includes providing a discard volatile shutdown (dvShutdown) command to the storage device, if the new system power state is shutdown/restart. Program flow may then proceed to operation 214.

Thus, temporary and/or persistent data may be stored to a storage device and the storage device may be instructed whether to store or invalidate the temporary data if a change in system power state is imminent.

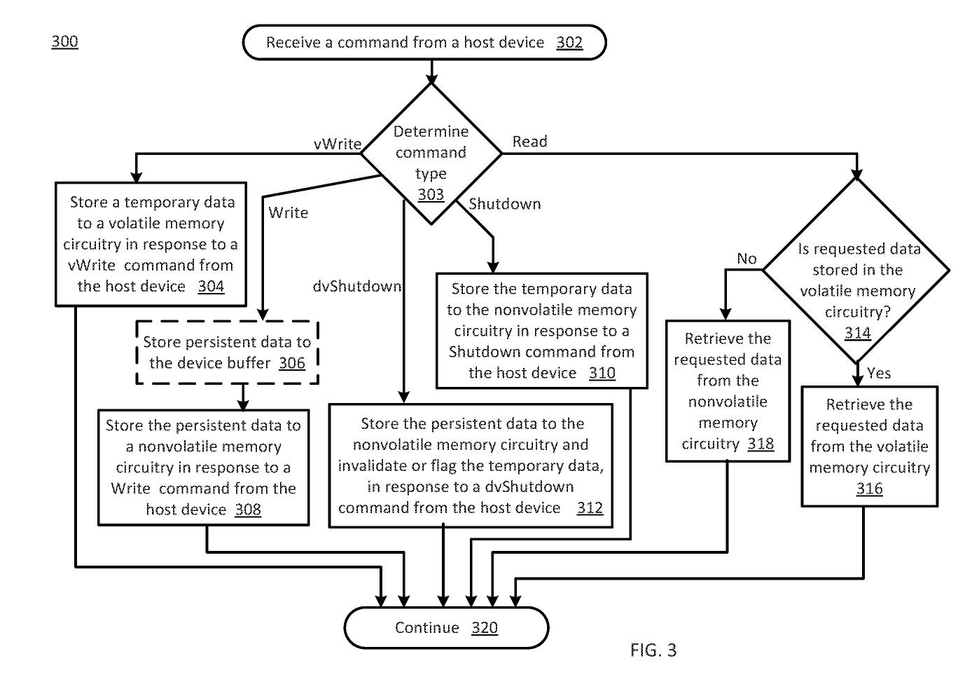

FIG. 3 is a flowchart 300 of storage device operations according to various embodiments of the present disclosure. In particular, the flowchart 300 illustrates storing temporary and/or persistent data by the storage device and storing or invalidating the temporary data in response to an instruction from a host device. The operations may be performed, for example, by storage device 104, e.g., device storage logic 136, of FIG. 1.

Operations of this embodiment may begin with receiving a command from a host device at operation 302. A type of command may be determined at operation 303. The types of command may include volatile write (vWrite), Write, discard volatile shutdown (dvShutdown), Shutdown and Read. If the type of command corresponds to vWrite, a temporary data may be stored to a volatile memory circuitry in response to the vWrite command from the host device, at operation 304. Program flow may then continue at operation 320. If the type of command corresponds to vWrite, in some embodiments, a persistent data may be stored to the device buffer at operation 306. If the type of command corresponds to vWrite, the persistent data may be stored to a nonvolatile memory circuitry in response to the Write command from a host device at operation 308. Program flow may then proceed to operation 320.

If the type of command corresponds to Shutdown, the temporary data may be stored to the nonvolatile memory circuitry in response to the Shutdown command from the host device at operation 310. Program flow may then proceed to operation 320. If the type of command corresponds to dvShutdown, the persistent data may be stored to the nonvolatile memory circuitry and the temporary data may be invalidated or flagged, in response to the dvShutdown command from the host device at operation 312. Program flow may then proceed to operation 320.

Operation 314 includes determining whether requested data, associated with a Read command received from the host device, is stored in the volatile memory circuitry. Operation 316 includes retrieving the requested data from the volatile memory circuitry if the requested data is stored in the volatile memory circuitry. Program flow may then proceed to operation 320. Operation 318 includes retrieving the requested data from the nonvolatile memory circuitry if the requested data is not stored in the volatile memory circuitry. Program flow may then proceed to operation 320.

Thus, temporary and/or persistent data may be stored by the storage device. The temporary data may be stored for retrieval across standby/hibernate (i.e., in response to a Shutdown command) or invalidated across shutdown/restart and/or power failure (i.e., in response to a dvShutdown command and/or a power loss imminent indicator).

While the flowcharts of FIGS. 2 and 3 illustrate operations according various embodiments, it is to be understood that not all of the operations depicted in FIGS. 2 and 3 are necessary for other embodiments. In addition, it is fully contemplated herein that in other embodiments of the present disclosure, the operations depicted in FIGS. 2 and/or 3 and/or other operations described herein may be combined in a manner not specifically shown in any of the drawings, and such embodiments may include less or more operations than are illustrated in FIGS. 2 and 3. Thus, claims directed to features and/or operations that are not exactly shown in one drawing are deemed within the scope and content of the present disclosure.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry 110, 130 executing code and/or instructions sets (e.g., software, firmware, etc.) corresponding to the functionality described herein, thus transforming a general-purpose processor into a specific-purpose processing environment to perform one or more of the operations described herein. In some embodiments, the various components and circuitry of the memory controller circuitry or other systems may be combined in a system-on-a-chip (SoC) architecture.

The foregoing provides example system architectures and methodologies, however, modifications to the present disclosure are possible. The processors may include one or more processor cores and may be configured to execute system software. System software may include, for example, an operating system. Device memory may include I/O memory buffers configured to store one or more data packets that are to be transmitted by, or received by, a network interface.

The operating system (OS) 118 may be configured to manage system resources and control tasks that are run on, e.g., host device 102. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units. The operating system and/or virtual machine may implement a protocol stack. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network.

Memory circuitry 112, 114 may include one or more of the following types of memory: semiconductor firmware memory, programmable memory, nonvolatile memory, read only memory, electrically programmable memory, random access memory, flash memory, magnetic disk memory, and/or optical disk memory. Either additionally or alternatively memory circuitry may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The computer-readable storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of computer-readable storage devices suitable for storing electronic instructions.

Host storage logic 122 and device storage logic 136 may be configured to provide and execute, respectively, commands 106, as described herein. Commands 106 may include for example, Write, Shutdown and Standby-immediate. In some embodiments, commands 106 may further include vWrite and/or dvShutdown commands, as described herein. Host storage logic 122, device storage logic 136 and/or one or more of commands 106 may comply or be compatible with a nonvolatile memory (NVM) specification related to communication with, and operation of, storage devices. For example, host storage logic 122, device storage logic 136 and/or one or more of commands 106 may comply with a NVM specification titled: NVM Express®, Revision 1.2, released November 2014, by NVM Express Workgroup, and/or Revision 1.2.1, released June 2016, and/or later and/or related versions of this specification, e.g., Revision 1.3, released May 2017.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

In some embodiments, a Verilog hardware description language (HDL) may be used to specify circuit and/or logic implementation(s) for the various logic and/or circuitry described herein. For example, in one embodiment, the HDL may comply or be compatible with IEEE standard 62530-2011: SystemVerilog—Unified Hardware Design, Specification, and Verification Language, dated Jul. 7, 2011; IEEE Std 1800™-2012: IEEE Standard for SystemVerilog-Unified Hardware Design, Specification, and Verification Language, released Feb. 21, 2013; IEEE standard 1364-2005: IEEE Standard for Verilog Hardware Description Language, dated Apr. 18, 2006 and/or other versions of Verilog HDL and/or SystemVerilog standards.

### EXAMPLES

Examples of the present disclosure include subject material such as a method, means for performing acts of the method, a device, or of an apparatus or system related to selective temporary data storage, as discussed below.

### Example 1

According to this example, there is provided a host device. The host device includes a host processor circuitry; a host memory circuitry, and a host storage logic. The host storage logic is to determine whether a data to be stored is temporary or persistent. The host device is further to provide a write (Write) command associated with the data to a storage device, if the data is persistent data, or to provide a volatile write (vWrite) command associated with the data to the storage device, if the data is temporary data.

### Example 2

This example includes the elements of example 1, wherein the host storage logic is to determine whether a new system power state corresponds to at least one of standby and/or hibernate (standby/hibernate) or at least one of shutdown and/or restart (shutdown/restart) and to provide a shutdown (Shutdown) command to the storage device if the new system power state is standby/hibernate or a discard volatile shutdown (dvShutdown) command to the storage device, if the new system power state is shutdown/restart.

### Example 3

This example includes the elements of example 1 or 2, wherein the vWrite command is to indicate to the storage device that the associated data is temporary.

### Example 4

This example includes the elements of example 2, wherein the new system power state is determined in response to detecting an indication of an imminent change from a current system power state.

### Example 5

This example includes the elements of example 2 or 4, wherein the dvShutdown command is to instruct the storage device to store the persistent data to a nonvolatile memory circuitry.

### Example 6

This example includes the elements of example 2 or 4, wherein the dvShutdown command is to instruct the storage device to invalidate the temporary data.

### Example 7

This example includes the elements of example 2 or 4, wherein the Shutdown command is to instruct the storage device to store the persistent data and the temporary data to a nonvolatile memory circuitry.

### Example 8

According to this example, there is provided a method. The method includes determining, by a host storage logic, whether a data to be stored is temporary or persistent. The method further includes providing, by the host storage logic, a write (Write) command associated with the data to a storage device, if the data is persistent data, or providing, by the host storage logic, a volatile write (vWrite) command associated with the data to the storage device, if the data is temporary data.

### Example 9

This example includes the elements of example 8, further including determining, by the host storage logic, whether a new system power state corresponds to at least one of standby and/or hibernate (standby/hibernate) or at least one of shutdown and/or restart (shutdown/restart); and providing, by the host storage logic, a shutdown (Shutdown) command to the storage device if the new system power state is standby/hibernate or providing, by the host storage logic, a discard volatile shutdown (dvShutdown) command to the storage device, if the new system power state is shutdown/restart.

### Example 10

This example includes the elements of example 8, wherein the vWrite command is to indicate to the storage device that the associated data is temporary.

### Example 11

This example includes the elements of example 9, wherein the new system power state is determined in response to detecting an indication of an imminent change from a current system power state.

### Example 12

This example includes the elements of example 9, wherein the dvShutdown command is to instruct the storage device to store the persistent data to a nonvolatile memory circuitry.

### Example 13

This example includes the elements of example 9, wherein the dvShutdown command is to instruct the storage device to invalidate the temporary data.

### Example 14

This example includes the elements of example 9, wherein the Shutdown command is to instruct the storage device to store the persistent data and the temporary data to a nonvolatile memory circuitry.

### Example 15

According to this example, there is provided a storage device. The storage device includes a device processor circuitry; a volatile memory circuitry; a nonvolatile memory circuitry; and a device storage logic. The device storage logic is to store a persistent data to the nonvolatile memory circuitry in response to a write (Write) command from a host device and a temporary data to the volatile memory circuitry in response to a volatile write (vWrite) command from the host device.

### Example 16

This example includes the elements of example 15, wherein the device storage logic is further to store the temporary data to the nonvolatile memory circuitry in response to a shutdown (Shutdown) command from the host device.

### Example 17

This example includes the elements of example 15, wherein the device storage logic is further to store the persistent data to the nonvolatile memory circuitry and to invalidate or flag the temporary data, in response to a discard volatile shutdown (dvShutdown) command from the host device and/or a power loss imminent indicator.

### Example 18

This example includes the elements according to any one of examples 15 to 17, wherein the device storage logic is further to determine whether requested data associated with a read command received from the host device is stored in the volatile memory circuitry, and to retrieve the requested data from the volatile memory circuitry if the requested data is stored in the volatile memory circuitry or from the nonvolatile memory circuitry if the requested data is not stored in the volatile memory circuitry.

### Example 19

This example includes the elements according to any one of examples 15 to 17, wherein the device storage logic is further to store the persistent data to the volatile memory circuitry, prior to storing the persistent data to the nonvolatile memory circuitry.

### Example 20

This example includes the elements according to any one of examples 15 to 17, wherein the volatile memory circuitry includes a volatile buffer circuitry to store the temporary data and a persistent buffer circuitry to store the persistent data.

### Example 21

This example includes the elements according to any one of examples 15 to 17, wherein the nonvolatile memory circuitry is selected from the group including a NAND flash memory, a NOR memory, a solid state memory, a first nonvolatile memory circuitry that includes chalcogenide phase change material, a ferroelectric memory, a silicon-oxide-nitride-oxide-silicon (SONOS) memory, a polymer memory, a byte addressable random accessible three-dimensional (3D) crosspoint memory, a ferroelectric transistor random access memory (Fe-TRAM), a magnetoresistive random access memory (MRAM), a phase change memory, a resistive memory, a ferroelectric memory, a spin-transfer torque memory (STT), a thermal assisted switching memory (TAS), a millipede memory, a floating junction gate memory (FJG RAM), a magnetic tunnel junction (MTJ) memory, an electrochemical cells (ECM) memory, a binary oxide filament cell memory, an interfacial switching memory, a battery-backed RAM, an ovonic memory, a nanowire memory and/or an electrically erasable programmable read-only memory (EEPROM).

### Example 22

This example includes the elements according to any one of examples 15 to 17, wherein the volatile memory circuitry includes at least one of dynamic random access memory (DRAM) and/or static random access memory (SRAM).

### Example 23

According to this example, there is provided a method. The method includes storing, by a device storage logic, a persistent data to a nonvolatile memory circuitry in response to a write (Write) command from a host device. The method further includes storing, by the device storage logic, a temporary data to a volatile memory circuitry in response to a volatile write (vWrite) command from the host device.

### Example 24

This example includes the elements of example 23, further including storing, by the device storage logic, the temporary data to the nonvolatile memory circuitry in response to a shutdown (Shutdown) command from the host device.

### Example 25

This example includes the elements of example 23, further including storing, by the device storage logic, the persistent data to the nonvolatile memory circuitry, and invalidating or flagging, by the device storage logic, the temporary data, in response to a discard volatile shutdown (dvShutdown) command from the host device and/or a power loss imminent indicator.

### Example 26

This example includes the elements of example 23, further including determining, by the device storage logic, whether requested data associated with a read command received from the host device is stored in the volatile memory circuitry; and retrieving, by the device storage logic, the requested data from the volatile memory circuitry if the requested data is stored in the volatile memory circuitry or from the nonvolatile memory circuitry if the requested data is not stored in the volatile memory circuitry.

### Example 27

This example includes the elements of example 23, further including storing, by the device storage logic, the persistent data to the volatile memory circuitry, prior to storing the persistent data to the nonvolatile memory circuitry.

### Example 28

This example includes the elements of example 23, wherein the volatile memory circuitry includes a volatile buffer circuitry to store the temporary data and a persistent buffer circuitry to store the persistent data.

### Example 29

This example includes the elements of example 23, wherein the nonvolatile memory circuitry is selected from the group including a NAND flash memory, a NOR memory, a solid state memory, a first nonvolatile memory circuitry that includes chalcogenide phase change material, a ferroelectric memory, a silicon-oxide-nitride-oxide-silicon (SONOS) memory, a polymer memory, a byte addressable random accessible three-dimensional (3D) crosspoint memory, a ferroelectric transistor random access memory (Fe-TRAM), a magnetoresistive random access memory (MRAM), a phase change memory, a resistive memory, a ferroelectric memory, a spin-transfer torque memory (STT), a thermal assisted switching memory (TAS), a millipede memory, a floating junction gate memory (FJG RAM), a magnetic tunnel junction (MTJ) memory, an electrochemical cells (ECM) memory, a binary oxide filament cell memory, an interfacial switching memory, a battery-backed RAM, an ovonic memory, a nanowire memory and/or an electrically erasable programmable read-only memory (EEPROM).

### Example 30

This example includes the elements of example 23, wherein the volatile memory circuitry includes at least one of dynamic random access memory (DRAM) and/or static random access memory (SRAM).

### Example 31

According to this example, there is provided a computer readable storage device. The device has stored thereon instructions that when executed by one or more processors result in the following operations including: determining whether a data to be stored is temporary or persistent. The operations further include providing a write (Write) command associated with the data to a storage device, if the data is persistent data, or providing a volatile write (vWrite) command associated with the data to the storage device, if the data is temporary data.

### Example 32

This example includes the elements of example 31, wherein the instructions that when executed by one or more processors results in the following additional operations including determining whether a new system power state corresponds to at least one of standby and/or hibernate (standby/hibernate) or at least one of shutdown and/or restart (shutdown/restart); and providing a shutdown (Shutdown) command to the storage device if the new system power state is standby/hibernate or providing a discard volatile shutdown (dvShutdown) command to the storage device, if the new system power state is shutdown/restart.

### Example 33

This example includes the elements of example 31 or 32, wherein the vWrite command is to indicate to the storage device that the associated data is temporary.

### Example 34

This example includes the elements of example 32, wherein the new system power state is determined in response to detecting an indication of an imminent change from a current system power state.

### Example 35

This example includes the elements of example 32 or 34, wherein the dvShutdown command is to instruct the storage device to store the persistent data to a nonvolatile memory circuitry.

### Example 36

This example includes the elements of example 32 or 34, wherein the dvShutdown command is to instruct the storage device to invalidate the temporary data.

### Example 37

This example includes the elements of example 32 or 34, wherein the Shutdown command is to instruct the storage device to store the persistent data and the temporary data to a nonvolatile memory circuitry.

### Example 38

According to this example, there is provided a computer readable storage device. The device has stored thereon instructions that when executed by one or more processors result in the following operations including storing a persistent data to a nonvolatile memory circuitry in response to a write (Write) command from a host device; and storing a temporary data to a volatile memory circuitry in response to a volatile write (vWrite) command from the host device.

### Example 39

This example includes the elements of example 38, wherein the instructions that when executed by one or more processors results in the following additional operations including storing the temporary data to the nonvolatile memory circuitry in response to a shutdown (Shutdown) command from the host device.

### Example 40

This example includes the elements of example 38, wherein the instructions that when executed by one or more processors results in the following additional operations including storing the persistent data to the nonvolatile memory circuitry and invalidating or flagging the temporary data, in response to a discard volatile shutdown (dvShutdown) command from the host device and/or a power loss imminent indicator.

### Example 41

This example includes the elements according to any one of examples 38 to 40, wherein the instructions that when executed by one or more processors results in the following additional operations including determining whether requested data associated with a read command received from the host device is stored in the volatile memory circuitry, and retrieving the requested data from the volatile memory circuitry if the requested data is stored in the volatile memory circuitry or from the nonvolatile memory circuitry if the requested data is not stored in the volatile memory circuitry.

### Example 42

This example includes the elements according to any one of examples 38 to 40, wherein the instructions that when executed by one or more processors results in the following additional operations including storing the persistent data to the volatile memory circuitry, prior to storing the persistent data to the nonvolatile memory circuitry.

### Example 43

This example includes the elements according to any one of examples 38 to 40, wherein the volatile memory circuitry includes a volatile buffer circuitry to store the temporary data and a persistent buffer circuitry to store the persistent data.

### Example 44

This example includes the elements according to any one of examples 38 to 40, wherein the nonvolatile memory circuitry is selected from the group including a NAND flash memory, a NOR memory, a solid state memory, a first nonvolatile memory circuitry that includes chalcogenide phase change material, a ferroelectric memory, a silicon-oxide-nitride-oxide-silicon (SONOS) memory, a polymer memory, a byte addressable random accessible three-dimensional (3D) crosspoint memory, a ferroelectric transistor random access memory (Fe-TRAM), a magnetoresistive random access memory (MRAM), a phase change memory, a resistive memory, a ferroelectric memory, a spin-transfer torque memory (STT), a thermal assisted switching memory (TAS), a millipede memory, a floating junction gate memory (FJG RAM), a magnetic tunnel junction (MTJ) memory, an electrochemical cells (ECM) memory, a binary oxide filament cell memory, an interfacial switching memory, a battery-backed RAM, an ovonic memory, a nanowire memory and/or an electrically erasable programmable read-only memory (EEPROM).

### Example 45

This example includes the elements according to any one of examples 38 to 40, wherein the volatile memory circuitry includes at least one of dynamic random access memory (DRAM) and/or static random access memory (SRAM).

### Example 46

This example includes the elements according to any one of examples 38 to 40, wherein the instructions that when executed by one or more processors results in the following additional operations including.

### Example 47

According to this example, there is provided a host device. The host device includes means for determining, by a host storage logic, whether a data to be stored is temporary or persistent. The host device further includes means for providing, by the host storage logic, a write (Write) command associated with the data to a storage device, if the data is persistent data, or means for providing, by the host storage logic, a volatile write (vWrite) command associated with the data to the storage device, if the data is temporary data.

### Example 48

This example includes the elements of example 47, further including means for determining, by the host storage logic, whether a new system power state corresponds to at least one of standby and/or hibernate (standby/hibernate) or at least one of shutdown and/or restart (shutdown/restart); and means for providing, by the host storage logic, a shutdown (Shutdown) command to the storage device if the new system power state is standby/hibernate or providing, by the host storage logic, a discard volatile shutdown (dvShutdown) command to the storage device, if the new system power state is shutdown/restart.

### Example 49

This example includes the elements of example 47 or 48, wherein the vWrite command is to indicate to the storage device that the associated data is temporary.

### Example 50

This example includes the elements of example 48, wherein the new system power state is determined in response to detecting an indication of an imminent change from a current system power state.

### Example 51

This example includes the elements of example 48 or 50, wherein the dvShutdown command is to instruct the storage device to store the persistent data to a nonvolatile memory circuitry.

### Example 52

This example includes the elements of example 48 or 50, wherein the dvShutdown command is to instruct the storage device to invalidate the temporary data.

### Example 53

This example includes the elements of example 48 or 50, wherein the Shutdown command is to instruct the storage device to store the persistent data and the temporary data to a nonvolatile memory circuitry.

### Example 54

According to this example, there is provided a storage device. The storage device includes means for storing, by a device storage logic, a persistent data to a nonvolatile memory circuitry in response to a write (Write) command from a host device; and means for storing, by the device storage logic, a temporary data to a volatile memory circuitry in response to a volatile write (vWrite) command from the host device.

### Example 55

This example includes the elements of example 54, further including means for storing, by the device storage logic, the temporary data to the nonvolatile memory circuitry in response to a shutdown (Shutdown) command from the host device.

### Example 56

This example includes the elements of example 54, further including means for storing, by the device storage logic, the persistent data to the nonvolatile memory circuitry, and means for invalidating or flagging, by the device storage logic, the temporary data, in response to a discard volatile shutdown (dvShutdown) command from the host device and/or a power loss imminent indicator.

### Example 57

This example includes the elements according to any one of examples 54 to 56, further including means for determining, by the device storage logic, whether requested data associated with a read command received from the host device is stored in the volatile memory circuitry; and means for retrieving, by the device storage logic, the requested data from the volatile memory circuitry if the requested data is stored in the volatile memory circuitry or from the nonvolatile memory circuitry if the requested data is not stored in the volatile memory circuitry.

### Example 58

This example includes the elements according to any one of examples 54 to 56, further including means for storing, by the device storage logic, the persistent data to the volatile memory circuitry, prior to storing the persistent data to the nonvolatile memory circuitry.

### Example 59

This example includes the elements according to any one of examples 54 to 56, wherein the volatile memory circuitry includes a volatile buffer circuitry to store the temporary data and a persistent buffer circuitry to store the persistent data.

### Example 60

This example includes the elements according to any one of examples 54 to 56, wherein the nonvolatile memory circuitry is selected from the group including a NAND flash memory, a NOR memory, a solid state memory, a first nonvolatile memory circuitry that includes chalcogenide phase change material, a ferroelectric memory, a silicon-oxide-nitride-oxide-silicon (SONOS) memory, a polymer memory, a byte addressable random accessible three-dimensional (3D) crosspoint memory, a ferroelectric transistor random access memory (Fe-TRAM), a magnetoresistive random access memory (MRAM), a phase change memory, a resistive memory, a ferroelectric memory, a spin-transfer torque memory (STT), a thermal assisted switching memory (TAS), a millipede memory, a floating junction gate memory (FJG RAM), a magnetic tunnel junction (MTJ) memory, an electrochemical cells (ECM) memory, a binary oxide filament cell memory, an interfacial switching memory, a battery-backed RAM, an ovonic memory, a nanowire memory and/or an electrically erasable programmable read-only memory (EEPROM).

### Example 61

This example includes the elements according to any one of examples 54 to 56, wherein the volatile memory circuitry includes at least one of dynamic random access memory (DRAM) and/or static random access memory (SRAM).

### Example 62

This example includes the elements of example 17, wherein the device storage logic is to invalidate the flagged temporary data following a subsequent power up.

### Example 63

This example includes the elements of example 25, further including invalidating, by the device storage logic, the flagged temporary data, following a subsequent power up

### Example 64

This example includes the elements of example 40, wherein the instructions that when executed by one or more processors results in the following additional operations including invalidating the flagged temporary data, following a subsequent power up.

### Example 65

This example includes the elements of example 56, further including means for invalidating, by the device storage logic, the flagged temporary data, following a subsequent power up.

### Example 66

According to this example, there is provided a system. The system includes at least one device arranged to perform the method of any one of examples 8 to 14.

### Example 67

According to this example, there is provided a device. The device includes means to perform the method of any one of examples 8 to 14.

### Example 68

According to this example, there is provided a computer readable storage device. The device has stored thereon instructions that when executed by one or more processors result in the following operations including: the method according to any one of examples 8 to 14.

### Example 69

According to this example, there is provided a system. The system includes at least one device arranged to perform the method of any one of examples 23 to 30 or 63.

### Example 70

According to this example, there is provided a device. The device includes means to perform the method of any one of examples 23 to 30 or 63.

### Example 71

According to this example, there is provided a computer readable storage device. The device has stored thereon instructions that when executed by one or more processors result in the following operations including: the method according to any one of examples 23 to 30 or 63.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A host device comprising:
a host processor circuitry;
a host memory circuitry, and
a host storage logic to determine whether a data to be stored is temporary or persistent and to provide a write (Write) command associated with the data to a storage device, if the data is persistent data, or to provide a volatile write (vWrite) command associated with the data to the storage device, if the data is temporary data.

2. The host device of claim 1, wherein the host storage logic is to determine whether a new system power state corresponds to at least one of standby and/or hibernate (standby/hibernate) or at least one of shutdown and/or restart (shutdown/restart) and to provide a shutdown (Shutdown) command to the storage device if the new system power state is standby/hibernate or a discard volatile shutdown (dvShutdown) command to the storage device, if the new system power state is shutdown/restart.

3. The host device of claim 1, wherein the vWrite command is to indicate to the storage device that the associated data is temporary.

4. The host device of claim 2, wherein the dvShutdown command is to instruct the storage device to store the persistent data to a nonvolatile memory circuitry and to invalidate the temporary data.

5. The host device of claim 2, wherein the Shutdown command is to instruct the storage device to store the persistent data and the temporary data to a nonvolatile memory circuitry.

6. A method comprising:
determining, by a host storage logic, whether a data to be stored is temporary or persistent; and
providing, by the host storage logic, a write (Write) command associated with the data to a storage device, if the data is persistent data, or
providing, by the host storage logic, a volatile write (vWrite) command associated with the data to the storage device, if the data is temporary data.

7. The method of claim 6, further comprising determining, by the host storage logic, whether a new system power state corresponds to at least one of standby and/or hibernate (standby/hibernate) or at least one of shutdown and/or restart (shutdown/restart); and providing, by the host storage logic, a shutdown (Shutdown) command to the storage device if the new system power state is standby/hibernate or providing, by the host storage logic, a discard volatile shutdown (dvShutdown) command to the storage device, if the new system power state is shutdown/restart.

8. The method of claim 6, wherein the vWrite command is to indicate to the storage device that the associated data is temporary.

9. The method of claim 7, wherein the dvShutdown command is to instruct the storage device to store the persistent data to a nonvolatile memory circuitry and to invalidate the temporary data.

10. The method of claim 7, wherein the Shutdown command is to instruct the storage device to store the persistent data and the temporary data to a nonvolatile memory circuitry.

11. A storage device comprising:
a device processor circuitry;
a volatile memory circuitry;
a nonvolatile memory circuitry; and
a device storage logic to store a persistent data to the nonvolatile memory circuitry in response to a write (Write) command from a host device and a temporary data to the volatile memory circuitry in response to a volatile write (vWrite) command from the host device.

12. The storage device of claim 11, wherein the device storage logic is further to store the temporary data to the nonvolatile memory circuitry in response to a shutdown (Shutdown) command from the host device.

13. The storage device of claim 11, wherein the device storage logic is further to store the persistent data to the nonvolatile memory circuitry and to invalidate or flag the temporary data, in response to a discard volatile shutdown (dvShutdown) command from the host device and/or a power loss imminent indicator.

14. The storage device of claim 11, wherein the device storage logic is further to determine whether requested data associated with a read command received from the host device is stored in the volatile memory circuitry, and to retrieve the requested data from the volatile memory circuitry if the requested data is stored in the volatile memory circuitry or from the nonvolatile memory circuitry if the requested data is not stored in the volatile memory circuitry.

15. The storage device of claim 11, wherein the volatile memory circuitry comprises a volatile buffer circuitry to store the temporary data and a persistent buffer circuitry to store the persistent data.

16. The storage device of claim 13, wherein the device storage logic is to invalidate the flagged temporary data following a subsequent power up.

17. A method comprising:
storing, by a device storage logic, a persistent data to a nonvolatile memory circuitry in response to a write (Write) command from a host device; and
storing, by the device storage logic, a temporary data to a volatile memory circuitry in response to a volatile write (vWrite) command from the host device.

18. The method of claim 17, further comprising storing, by the device storage logic, the temporary data to the nonvolatile memory circuitry in response to a shutdown (Shutdown) command from the host device.

19. The method of claim 17, further comprising storing, by the device storage logic, the persistent data to the nonvolatile memory circuitry, and invalidating or flagging, by the device storage logic, the temporary data, in response to a discard volatile shutdown (dvShutdown) command from the host device and/or a power loss imminent indicator.

20. The method of claim 17, further comprising determining, by the device storage logic, whether requested data associated with a read command received from the host device is stored in the volatile memory circuitry; and retrieving, by the device storage logic, the requested data from the volatile memory circuitry if the requested data is stored in the volatile memory circuitry or from the nonvolatile memory circuitry if the requested data is not stored in the volatile memory circuitry.

21. The method of claim 17, wherein the volatile memory circuitry comprises a volatile buffer circuitry to store the temporary data and a persistent buffer circuitry to store the persistent data.

22. The method of claim 19, further comprising invalidating, by the device storage logic, the flagged temporary data, following a subsequent power up.
